(19) United States
(12) Patent Application Publication
(10) Pub. No.: US 2025/0308117 A1
(43) Pub. Date: Oct. 2, 2025

(54) SUBJECT-AGNOSTIC FACE SWAPPING WITH LOW-RANK ADAPTATION

(71) Applicants: Disney Enterprises, Inc., Burbank, CA (US); ETH Zürich (Eidgenössische Technische Hochschule Zürich), Zürich (CH)

(72) Inventors: Manuel Jakob Kansy, Horgen (CH); Joel Neuner-Jehle, Rotkreuz (CH); Jacek Krzysztof Naruniec, Zug (CH); Romann Matthew Weber, Uster (CH)

(73) Assignees: Disney Enterprises, Inc., Burbank, CA (US); ETH Zürich (Eidgenössische Technische Hochschule Zürich), Zürich (CH)

(21) Appl. No.: 19/094,056

(22) Filed: Mar. 28, 2025

Related U.S. Application Data
(60) Provisional application No. 63/572,770, filed on Apr. 1, 2024.

(51) Int. Cl. G06T 11/60; G06N 3/0455

(52) U.S. Cl. CPC G06T 11/60; G06N 3/0455

(57) ABSTRACT

In some embodiments, a method generates a first representation of a first image including a first facial identity and generates an identity representation from a second image that describes a second facial identity of the second image. The identity representation is mapped to a set of low-rank adaptation weights. The method adapts the first representation to an adapted first representation using the set of low-rank adaptation weights that are applied to a layer in a model. Decoder input values are generated based on the adapted first representation. The method performs decoding using the decoder input values to generate an output image. The output image swaps the first facial identity of the first image with the second facial identity of the second image..

### CROSS REFERENCE TO RELATED APPLICATIONS

Pursuant to 35 U.S.C. § 119(e), this application is entitled to and claims the benefit of the filing date of U.S. Provisional App. No. 63/572,770 filed Apr. 1, 2024, entitled “SUBJECT-AGNOSTIC FACE SWAPPING WITH LOW-RANK ADAPTATION”, the content of which is incorporated herein by reference in its entirety for all purposes.

### BACKGROUND

Face swapping refers to the changing of the facial identity of an individual in standalone images or video frames while maintaining the performance of the individual within the standalone images or video frames. This facial identity may include aspects of a facial appearance that arise from differences in personal identities, ages, eye colors, or other factors. For example, two different facial identities may be attributed to two different individuals, the same individual under different lighting conditions, or the same individual at different ages. Further, the performance of an individual, which also is referred to as the dynamic behavior of an individual, includes the facial expressions and poses of the individual, as depicted in the video frames or in standalone images.

Face swapping can be conducted under various types of scenarios. For example, the facial identity of an actor within a given scene of video content (e.g., a film, a show, etc.) could be changed to a different facial identity of the same actor at a younger age or at an older age. In another example, a first actor could be unavailable for a video shoot because of scheduling conflicts, because the first actor is deceased, or for other reasons. To incorporate the likeness of the first actor into video content generated during the shoot, footage of a second actor could be captured during the shoot, and the face of the second actor in the footage could be replaced with the face of the first actor afterwards.

Approaches commonly used in production are subject-specific, i.e., they require many images of the source subject, which may be difficult to obtain, as well as a training or fine-tuning of the model for each source subject, which can be prohibitively expensive for non-main actors. For example, a machine learning model can be trained on the facial identities of a set of individuals. Any of the facial identities can then be used as the face of a source individual for replacing the face of a target individual in a given input image. However, in the trained model, each of the facial identities can consume a large amount of memory, such as around 100 megabytes of memory. Thus, the size of the model can increase in proportion to the number of facial identities on which the model is trained, and the increase can be by a substantial amount of memory for each additional image. Also, if identity-specific fully connected layers are used, storage for all of the identity-specific fully connected layers is required.

### BRIEF DESCRIPTION OF THE DRAWINGS

The included drawings are for illustrative purposes and serve only to provide examples of possible structures and operations for the disclosed inventive systems, apparatus, methods, and computer program products. These drawings in no way limit any changes in form and detail that may be made by one skilled in the art without departing from the spirit and scope of the disclosed implementations.

FIG. 1 depicts a simplified system for performing face swapping according to some embodiments.

FIG. 2 depicts a more detailed example of a model according to some embodiments.

FIG. 3 depicts a simplified flowchart of a method for generating the low-rank adaptation weights according to some embodiments.

FIG. 4 depicts an example of the subject-specific weights according to some embodiments.

FIG. 5 depicts an example of a model for training using face swapping according to some embodiments.

FIG. 6 depicts an example of using adversarial loss to train the model according to some embodiments.

FIG. 7 depicts a simplified flowchart of a method for optimizing an identity representation of the source image according to some embodiments.

FIG. 8 illustrates one example of a computing device according to some embodiments.

### DETAILED DESCRIPTION

Described herein are techniques for a content analysis system. In the following description, for purposes of explanation, numerous examples and specific details are set forth to provide a thorough understanding of some embodiments. Some embodiments as defined by the claims may include some or all the features in these examples alone or in combination with other features described below, and may further include modifications and equivalents of the features and concepts described herein.

### System Overview

A system may train a model to be a subject-agnostic model, which may be a model that can swap facial identities without further training or fine-tuning of the model. The model may include a layer that is a subject-agnostic fully connected layer that uses subject-specific weights. While the system may be trained to perform subject-agnostic face swapping, during inference, the model performs face swapping of a target image based on a source image by adjusting the subject-specific weights in the subject-agnostic fully connected layer.

The system also reduces the memory footprint of the model. For example, to reach a model with generalization capabilities, the parameters needed per person should be minimized to enable scaling to datasets with several thousand identities. The system personalizes the subject-specific model weights without significant memory restrictions. Accordingly, the system replaces a subject-specific layer with a subject-agnostic fully connected layer and subject-specific weights that reside in a lower rank space (referred to as low rank adaption weights). The low-rank adaptation weights describe a low-rank adaptation weight change to the subject-agnostic fully connected layer for a specific source image. This results in a reduced memory footprint to produce face swaps for the source image. However, it is possible to generate a range of distinct identities by utilizing the low-rank adaptation weights instead of subject-specific fully connected layers per person.

### System

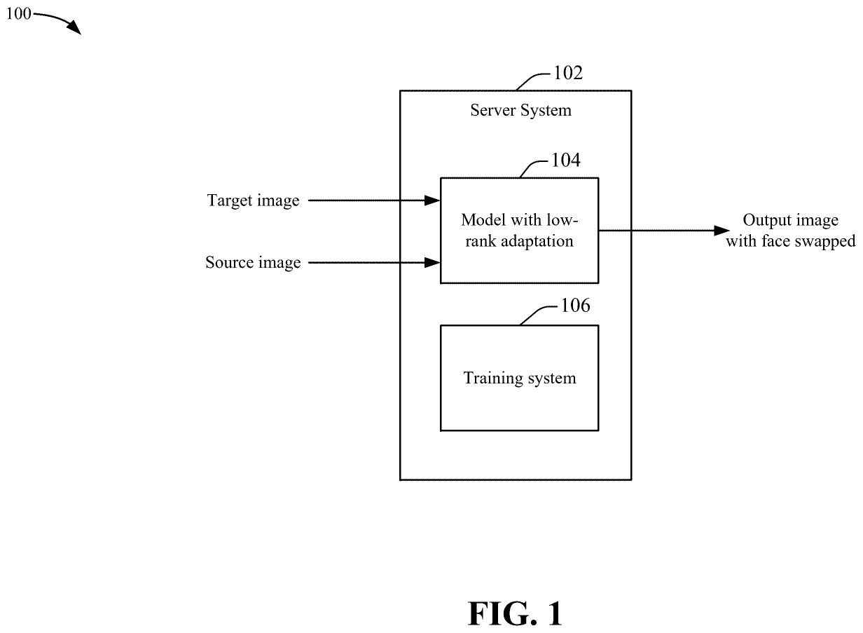

FIG. 1 depicts a simplified system 100 for performing face swapping according to some embodiments. Server system 102 includes a model 104 that performs face swapping and a training system 106 that trains model 104. Model 104 receives a target image and a source image. The target image or source image may be one or more images or video frames. Model 104 may swap a facial identity from target image with a facial identity from the source image. Model 104 outputs an image with the face swapped.

The facial identity may be associated with a face of an image. The facial identity may include aspects of a facial appearance that arise from personal identities, ages, eye colors, or other factors. For example, the target image or source image may include a normalized image of a face associated with the facial identity. This face can include (but is not limited to) a human face, an animal face, an animated face, a computer-generated face, or another representation of a region of a head that can be used to uniquely identify a human or non-human individual. Within the normalized image, landmarks or features of the face are aligned to match landmarks of a generic face with a neutral expression. As a result, facial features (e.g., eyes, cars, nose, etc.) are at similar locations across the normalized images. The normalized image can also be cropped to a predefined size. To generate the normalized image, server system 102 can rotate, scale, translate, crop, or otherwise process an original “non-normalized” image, such as an image of the face captured by a camera. Server system 102 can also, or instead, use a deep alignment network (DAN) (or another technique or machine learning model) to detect the largest face in each target image or source image and determine the locations of facial landmarks in the largest face. Server system 102 can then rotate, translate, crop, scale, perform color augmentation, or otherwise transform or process the image so that the eyes of the largest face lie on a predefined horizontal line and have a predefined ocular distance. Other methods of normalization may also be used.

Model 104 may not store subject-specific parameters for each identity of faces that are to be swapped. Rather, server system 102 may determine the identity from the source image at inference time when face swapping is to be performed. For example, server system 102 extracts a feature vector (e.g., identity representation) from characteristics of facial data for a facial identity from the source image. The identity representation describes the identity of the given source image using parameters. The identity representation is then mapped through a mapping network 214 to predict the low-rank adaptation weights for the identity. Mapping network 214 is trained to map different identity representations to different low-rank adaptation weights.

Model 104 applies the low-rank adaptation weights to a layer in a neural network in model 104. In some embodiments, the low-rank adaptation weights may be combined with subject-agnostic high-rank weights. The resulting weights are referred to as “subject-specific weights” and may be applied to a subject-specific neural network layer in model 104. The terms “low-rank” and “high-rank” refer to the number of independent parameters (e.g., components or dimensions, columns of the weight matrices, etc.) required to describe the weights. A low-rank weight matrix is one that can be approximated by a matrix with a relatively small number of independent parameters. In other words, the weight matrix can be represented as the product of two smaller matrices, each with a lower dimensionality than the original matrix. A high-rank weight matrix requires a larger number of independent parameters to describe it accurately. In this case, the weight matrix cannot be easily approximated by a lower-dimensional representation, and the full matrix is stored. The low-rank parameters reduces the number of parameters required to store and compute the weights. A weight matrix may have a size of 1000×1000. A high-rank representation of this matrix would require storing all 1,000,000 elements, and have a rank of 1000 (where the rank is the maximal number of independent columns/rows of a matrix). Whereas a low-rank representation has a rank lower than 1000 for this given matrix. The low-rank representation might approximate changes between different identities using two smaller matrices, such of size 1000×1 and 1×1000, reducing the number of parameters to 2,000. The low-rank representation may work to model changes between identities because it might be complex (e.g., high-rank) to model how a person's smile looks, but the differences between the smiles of two different people can be described more easily (e.g., low-rank), such as by one person opening the mouth further.

The use of the low-rank adaptation weights to represent the facial identity of the source image instead of personalizing all the weights of the layer may improve the usage of memory. For example, subject-specific weights for each specific facial identity that should be swapped do not need to be stored in a layer in model 104, such as before inference. Also, the use of low-rank adaptation weights may minimize the subject-specific parameters that have weights changed in a layer. This improves the efficiency of model 104. Further, as will be discussed below, the training of model 104 may use less resources because the quantity of training data that is required may be reduced. The use of lower rank weights reduces the trainable weights by a factor. Also, by minimizing the personalized weights of the low-rank adaptation weights, time and memory efficiency is achieved, as well as preserving favorable pre-trained properties. Although memory usage is reduced, realistic face swaps are still achieved.

In some embodiments, training system 106 trains model 104 to perform face swapping, in which the facial identity of an individual in a target image is changed with an individual in a source image while maintaining the performance of the individual within the target image. Training system 106 may use different training processes to improve the performance of model 104, which will be described in more detail below. First. the architecture of model 104 will be described in more detail, and then the training of model 104.

### Model Architecture

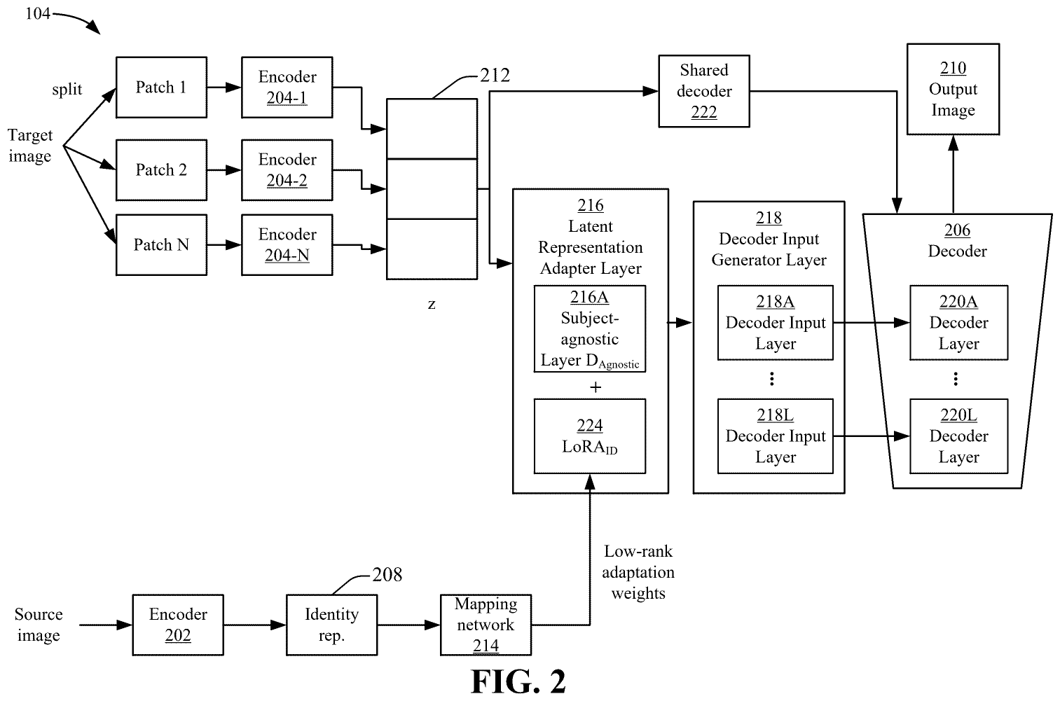

FIG. 2 depicts a more detailed example of model 104 according to some embodiments. Model 104 includes one or more encoders 204-1 to 204-N, latent representation adapter layer 216, decoder input generator layer 218, a shared decoder 222, and a decoder 206.

A target image is received as input to model 104. The target image may depict a scene including a face, which includes a first facial identity. The first facial identity can be swapped with a second facial identity from a source image that is received. Model 104 may split the image into different face region patches 1, 2, . . . , N to focus on the expression of each region separately, such as both eyes individually, mouth, and the rest of the face, etc. Although patches are described, the facial identity may not be split. Model 104 inputs images of different features into respective encoders 204-1 to 204-N that are separately trained to produce latent representations (e.g., latent embeddings) of the respective features. The latent representations may be combined, such as concatenated. The latent representation z 212 has information about attributes of the target image that may be independent of its facial identity, such as head pose, expression, eye gaze direction, or lighting conditions. In some embodiments, model 104 is an autoencoder that includes encoders 204 and decoder 206. Encoders 204 include convolutional layers, residual neural network (ResNet) layers, or other types of neural network layers that convert a 2D image that depicts a facial identity into a corresponding latent representation. This latent representation includes a fixed-length vector representation of the visual attributes in the respective image in a lower-dimensional space.

A source image may depict a scene including a face, which includes a second facial identity. The first facial identity is swapped with the second facial identity, In response to receiving the target image and the source image, model 104 generates an output image 210. Model 104 is trained to generate an output image 210 depicting a facial identity that resembles the second facial identity depicted in the source image.

Model 104 also processes the source image. An encoder 202 generates an identity representation 208, which describes the facial identity of the source image. In some embodiments, the facial identity is described using a reduced number of parameters, such as 512, compared to the parameters used to describe the latent representation of the target image. Model 204 passes identity representation 208 through a mapping network 214 to predict the low-rank adaptation weights. As will be discussed below, the low-rank adaptation weights are combined with subject-agnostic weights to generate subject-specific weights for the facial identity of the source image. The subject-specific weights are applied to a layer in a neural network of latent representation adapter layer 216. The identity representation may be processed in real-time when the face swapping is performed, or pre-processed to determine the low-rank adaptation weights.

Latent representation adapter layer 216 is executed to convert the latent representation 212 to an adapted latent representation to include the facial identity of the source image, which is input into decoder input generator layer 218. For example, the low-rank adaptation weights are used to adapt the latent representation z 212 to include information for the facial identity of the source image. Decoder input generate layer 218 generates decoder input values to input into decoder 206, and a decoder 206 converts the decoder input values to an output image 210. A shared decoder 222 can provide the latent representation 212 as input to the decoder 206 such that the facial identity of the source image can be swapped into the target image. The shared decoder 222, if present, is not influenced by the identity of the source image and thus decodes identity-free information about the pose and expression of the target image. Further, the shared decoder 222, can reshape and decode the target image up to a specified image resolution. Alternatively, the decoder 206 can reshape and decode the target image up to the specified image resolution, in which case the shared decoder 222 can be omitted.

The latent representation 212 and adapted latent representation can be, for example, a vector of 1024 elements, or a vector of other suitable size. The term “layer” as used herein refers to a neural network layer, which may be a fully connected layer or other type of layer, such as a convolutional layer. Latent representation adapter layer 216 and decoder layers 220 may include fully connected layers or convolutional layers. Although these layers are described, other types of neural network layers may be used.

Latent representation adapter layer 216 includes a subject-agnostic layer D_{agnostic} 216A and a set of low-rank adaptation weights 224 that process the latent representation z 212 to determine an adapted latent representation z_adapted. The adapted latent representation may incorporate the facial identity of the source image with the latent representation that was generated from the target image. For example, the latent representation z 212 may contain features except for facial identity of the target image, such as expression and lighting. Decoder input generator layer 218 receives the adapted latent representation. There may be L different sets of layers that all receive the adapted latent representation z_adapted as input. Each set has two layers, one that maps z_adapted to a scale and one that maps z_adapted to an offset. These values are then used to adapt the normalized latent representation within decoder 206. In some embodiments, decoder input layer 218A generates one or more first decoder values, which are provided as input to a first decoder layer 220A, and decoder input layer 218L generates one or more second decoder input values, which are provided as input to a second decoder layer 220L. Although two sets of decoder input generator layers 218, and two decoder layers 220 are shown, any suitable number of sets of decoder input generator layer 218 and decoder layers 220 can be used.

Latent representation adapter layer 216 may be shared and trained with multiple identities. A set of low-rank adaptation weights 224 in latent representation adapter layer 216 is adjusted for each new desired facial identity to be swapped during inference. The low-rank weights adapt the weights of subject-agnostic layer 216A.

Decoder 206 generates an output image 210 that is based on the target image but has the facial identity of the source image. The resulting decoding procedure takes the necessary attribute information from the target latent representation 212 and gradually modifies it to include the facial identity of the source image. The parameters provided to the decoder 206 can be AdaIN coefficients that control the operation of layers in the decoder, or the values of weights within such layers, allowing the model 104 to change the identity of a face in the target image to the facial identity of the source image in output image 210. Decoder 206, such as decoder layers 220A-220L, normalizes the mean and variance of the current features at a given level in the decoder channel-wise. The coefficients to steer these features are the result of trainable decoder input layers 218A-218L and are applied to features in decoder layers 220A-220L. The decoder input values can include coefficients, such as (AdaIN) coefficients. AdaIN (Adaptive Instance Normalization) coefficients are a set of learnable parameters used in the AdaIN normalization technique, which is a variant of instance normalization. The decoder input values can also, or instead, include weights associated with neurons within the layer(s) of decoder 206. The AdaIN coefficients or weights can be used to modify convolutional operations performed by the layer(s) 220 in decoder 206, thereby allowing decoder 206 to generate output images 210 with different facial identities.

The output image 210 depicts a facial identity generated by the decoder 206 based on the decoder input values. For example, the facial identity is generated based on the facial identity of the source image. In some embodiments, the output of the decoder 206 is passed through a convolution layer (not shown) to produce a 3-channel RGB image. The facial identity depicted in the output image 210 corresponds to the facial identity represented by the facial identity of the source image. The facial identity depicted in the output image 210 can be changed by changing the low-rank adaptation weights from the identity representation of the source image.

The use of the set of low-rank adaptation weights 224 improves on the prior models by having fewer subject-specific parameters. It thereby greatly reduces the memory footprint, which was a major drawback in previous models by limiting the number of concurrently trained identities.

### Low-Rank Adaptation Weight Generation

As discussed above, the system may further reduce the memory footprint of the model using the low-rank adaptation weights. Specifically, to reach a model with generalization capabilities, the parameters needed per person are minimized to enable scaling to datasets with several thousand identities. The subject-specific changes among the fully connected layer 216, which control the AdaIN coefficients for each person, reside in a lower rank space. Therefore, model 104 uses a set of low-rank adaptation weights 224 that personalize the identity-relevant model weights without significant memory restrictions.

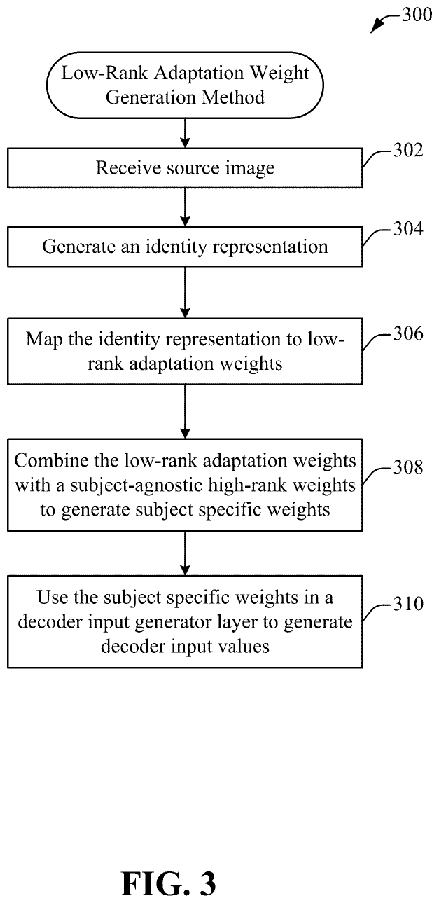

FIG. 3 depicts a simplified flowchart 300 of a method for generating the low-rank adaptation weights according to some embodiments. At 302, model 104 receives a source image. The source image includes a facial identity in which model 104 should swap with a facial identity of the target image.

At 304, model 104 generates an identity representation 208 from the source image. Encoder 202 may encode the facial characteristics of the facial identity into the identity representation 208. The facial identity may be a representation of the facial characteristics in a space.

At 306, mapping network 214 maps the identity representation to low-rank adaptation weights. In some embodiments, the low-rank adaptation weights are a rank 1 matrix for the subject-specific space to minimize the memory footprint when scaling to many identities, but other ranks may be used. The rank 1 matrix LoRA_{ID} describing the fully connected layer's weight change may be computed as the outer product of two vectors, namely the basis vector (e.g., the identity vector) and its multipliers. The multipliers may be used to scale the basis vector.

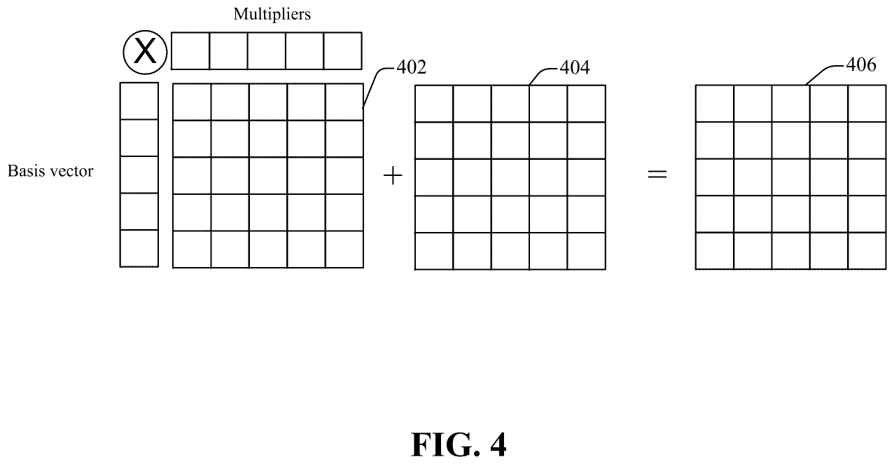

At 308, the rank 1 matrix LoRA_{ID} is combined (e.g., added) to the subject-agnostic full-rank matrix D_{Agnostic} to generate subject-specific weights for latent representation adapter layer 216. The addition is visualized in FIG. 4. By choosing the rank of this adaptation to be 1, the parameters stored for each person in the dataset are reduced by a factor of 512, from 1024\hat{ }2 per person to 2048. Another advantage given by this reduction of trainable parameters is that the training convergence time is reduced.

At 310, model 104 uses the subject-specific weights in a latent representation adapter layer 216 to generate the adapted latent representation. Model 104 uses the subject-specific weights to perform the face swap with the facial identity of the source image.

FIG. 4 depicts an example of the subject-specific weights according to some embodiments. At 402, a basis vector is multiplied by multipliers to generate the rank 1 matrix LoRA_{ID}, but other ranks may be used. A k-rank approximation of a full-rank matrix n×m splits the matrix n×m into two matrices, n×k and k×m. In the rank 1 case, k=1, which uses two vectors, n×1 and 1×m, which may be determined from the identity representation 208. For a higher rank approximation, a matrix with k rows and a matrix with k columns may be used. The mapping network 214 predicts the two matrices, n×k and k×m based on the identity representation 208. In this embodiment, the rank 1 matrix may be a size of n×m. The rank 1 matrix is added to the subject-agnostic high-rank matrix D_{Agnostic} at 404 to generate subject-specific weights D_{ID} at 406. The subject-agnostic high-rank matrix D_{Agnostic} may be of the size n×m and include weights that were previously trained to be generalized across multiple identities. The resulting subject-specific weights D_{ID} includes weights for latent representation adapter layer 216 (e.g., subject agnostic layer D_{Agnostic} 216A+LoRA_{ID}).

Training system 106 may use different training processes to improve the performance of model 104.

### Training

In some embodiments, model 104 may be trained based on reconstruction of a facial identity. That is, a single image is input into model 104, and an output image is reconstructed. The reconstruction loss is used to train parameters of model 104. The reconstruction may not robustly train model 104. To improve the training, training system 106 performs different training processes.

### Identity Preservation Loss

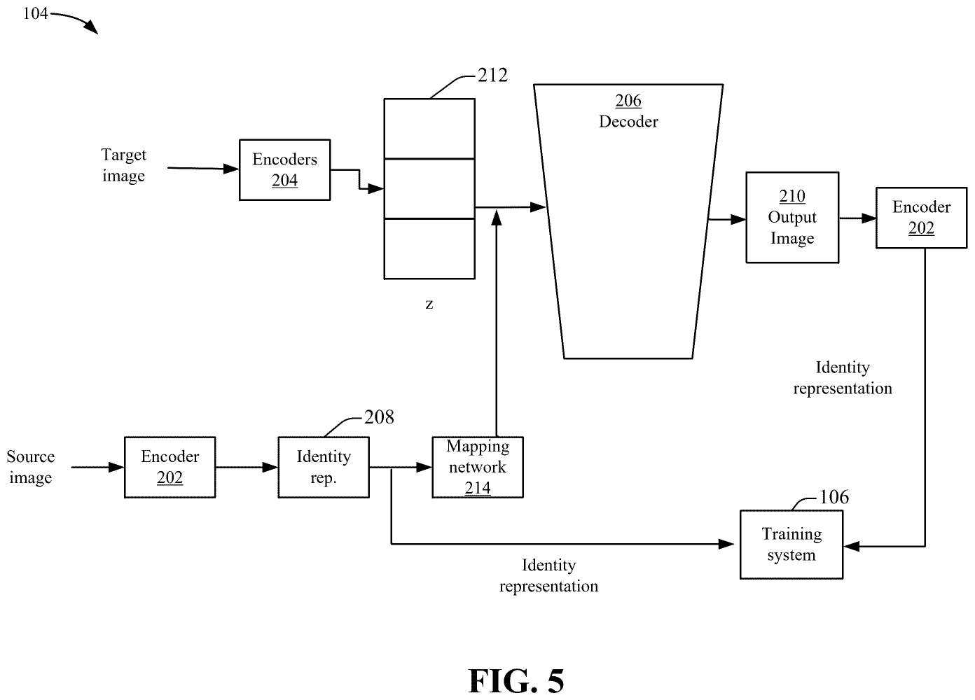

During training, model 104 performs face swapping, which is more than only using reconstruction to guide the training process. FIG. 5 depicts an example of model 104 for training using face swapping according to some embodiments. A simplified example of the logic of model 104 is shown. A source image and a target image are processed by model 104 as described above in FIG. 2. Output image 210 is a swapped image with the facial identity of the source image replacing the facial identity of the target image.

Output image 210 is fed to the same face recognition model (encoder 202) used to calculate the initial identity representation 208 of the source image. The identity representation of output image is input to training system 106. Then, training system 106 compares identity representation 208 of the source image to the identity representation of output image 210. The loss is defined as the distance (e.g., cosine distance) of the identity representations resulting from the original source identity image and the produced swap. Consequently, it enforces the preservation of the source identity regardless of which target pose or illumination is chosen. Both images may be subject to a binary face mask enforcing the loss function to only be applied within the face region.

This approach creates a trade-off between the previous loss functions, solely based on the reconstruction outputs, and the new identity preservation loss function, which also incorporates the output image with the swapped facial identity.

### Adversarial Loss

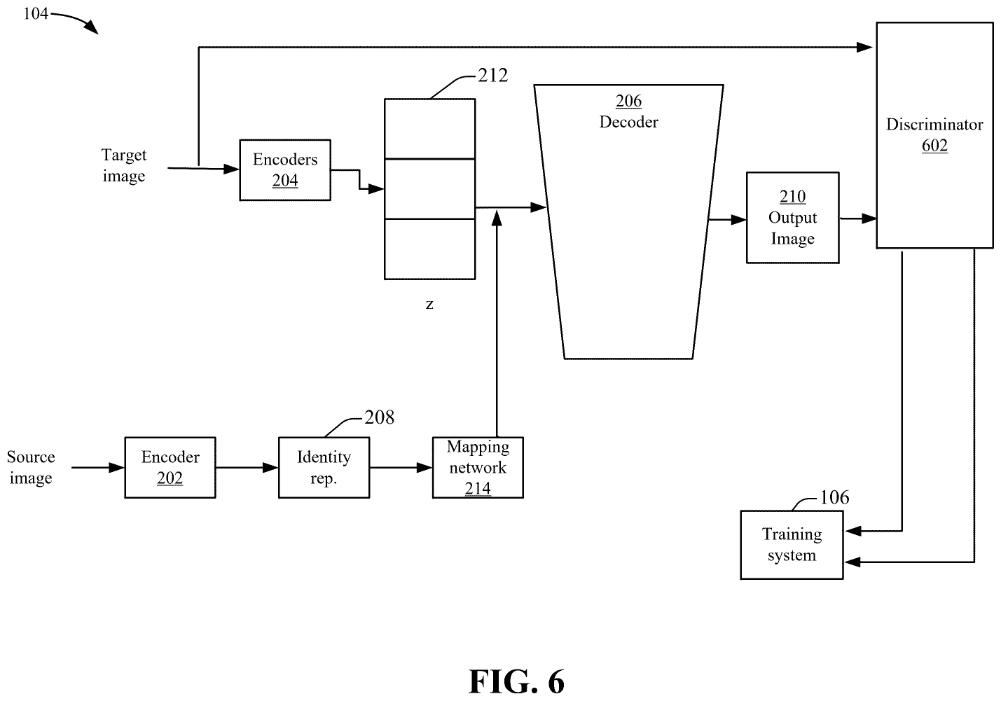

FIG. 6 depicts an example of using adversarial loss to train model 104 according to some embodiments. In contrast to deploying an adversarial loss on the produced reconstructions only, model 104 is trained on reconstructions and swapped output images. A discriminator 602 is trained simultaneously with model 104 and increases the realism and sharpness of the output images by classifying input images and produced output images as a first state or a second state, such as real or fake. Through simultaneous training model 104 gets better over time at tricking the discriminator 602 with realistic-looking output images 210, at the same time as the discriminator 602 improves its classification capabilities.

Training system 106 uses the previously introduced swapping of faces during training not only for the identity preservation loss but also for the adversarial loss. Discriminator 602 may output a score whether an input image is real or fake. Here, the input of discriminator 602 is either the target image or the swapped image. Note two arrows are input into discriminator 602 for illustration, but two inputs may not be input simultaneously. Rather, either of the target image or swapped image is input into discriminator 602 for an output. For example, when the input to discriminator 602 is the target image, discriminator 602 should output “real”. However, when the input to discriminator 602 is the swapped image, discriminator 602 should output “fake”. Real may mean the image is similar to the target image and fake may mean the image is not similar to the target image. The discriminator training process changes from using only reconstructed faces. Now with swapped faces also applied to the adversarial loss, discriminator 602 sees a whole new category of images and needs to adapt accordingly. For example, the training may result in adjusted parameters that produce images that show that the newly applied adversarial loss brings advantages in terms of realism and sharpness, containing more visible high-resolution details. Furthermore, side poses and extreme expressions seem more stable and the portrayed colors look more vibrant.

### Identity Vector Optimization

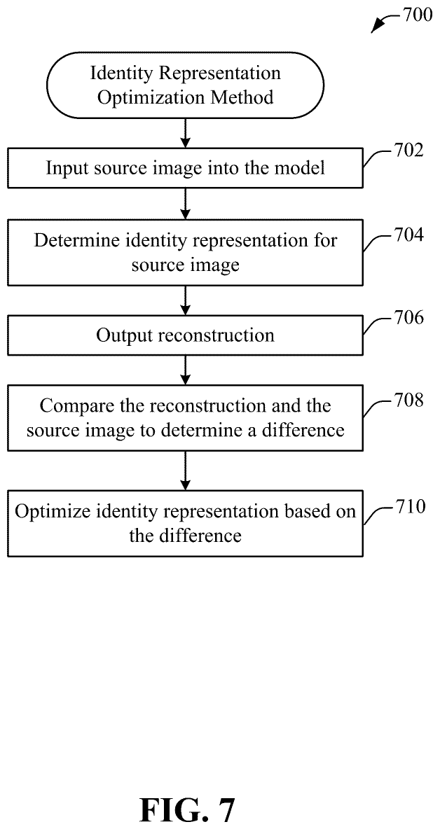

FIG. 7 depicts a simplified flowchart 700 of a method for optimizing an identity representation 208 of the source image according to some embodiments. As pre-trained subject-agnostic models are often not capable of perfectly capturing a previously unseen identity, training system 106 attempts to improve the identity generation process by finding a better identity representation 208 to describe the source image. In real-world applications of face swapping procedures, such as in the film industry, there are more than just a single image of the source person representing the desired identity available. Training system 106 may optimize the input identity representation 208 based on single or multiple images of the source person. The idea is to keep the pre-trained model frozen and refine the generated outputs by optimizing the input identity representation 208. Based on an initial identity representation 208 as a starting point, training system 106 can perform standard gradient descent on the structural dissimilarity of the reconstruction output to optimize identity representation 208. Given the advantage of having multiple images per person, training system 106 can further increase the robustness of the generated outputs. By using the available images as the target images for the model, training system 106 can then automatically use them as the ground truth for the produced reconstruction images.

At 702, a source image is input into model 104. The source image is the desired facial identity in which a face should be swapped.

At 704, model 104 determines an identity representation 208 for the source image. Then, at 706, model 104 outputs a reconstruction of the source image.

At 708, training system 106 compares the reconstruction and the source image to determine a difference. At 710, training system 106 optimizes the identity representation based on the difference. Training system 106 uses DSSIM as the dissimilarity metric for the reconstruction loss, but other similarity metrics may be used. The process may be performed for multiple images of the source.

This method can be used to improve the identity preservation of previously unseen people by adapting identity representation 208. The advantages of this approach are the very fast convergence and termination through freezing the large face swapping model's weights, as well as increasing the robustness if by any chance the initial identity representation 208 did not cover the person's distinctive attributes in the output space completely.

The above losses may be used in a final loss function. For example, the losses may be combined in a weighted sum. For example, the identity preservation loss and adversarial loss may be combined using a swapped image or reconstructed image. Also, other losses may be used in combination with the above losses. The training may also be performed serially where one method is performed first and a second method is performed second. The identity vector optimization may be performed after the training.

### Conclusion

Accordingly, the disclosed techniques train and execute a machine learning model that performs face swapping using reduced-size representations of facial identity. In some embodiments, low-rank adaptation weights are determined for the facial identity and combined with subject-agnostic weights to determine subject-specific weights for the subject-specific layer. One technical advantage is that the low-rank adaptation weights reduces the memory footprint. For example, parameters for specific identities do not need to be stored and retrieved. Further, less parameters need to be personalized using the low-rank adaptation weights while training processes maintain and improve the quality of the face swapping.

### System

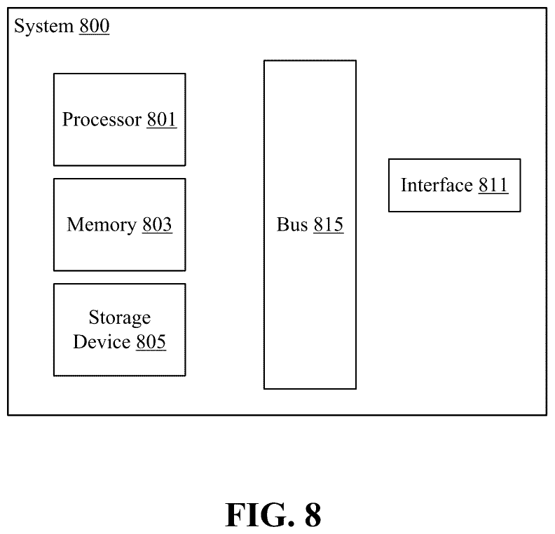

FIG. 8 illustrates one example of a computing device according to some embodiments. According to various embodiments, a system 800 suitable for implementing embodiments described herein includes a processor 801, a memory 803, a storage device 805, an interface 811, and a bus 815 (e.g., a PCI bus or other interconnection fabric.) System 800 may operate as a variety of devices such as server system 102, or any other device or service described herein. Although a particular configuration is described, a variety of alternative configurations are possible. Processor 801 may perform operations such as those described herein. Instructions for performing such operations may be embodied in memory 803, on one or more non-transitory computer readable media, or on some other storage device. Various specially configured devices can also be used in place of or in addition to processor 801. Memory 803 may be random access memory (RAM) or other dynamic storage devices. Storage device 805 may include a non-transitory computer-readable storage medium holding information, instructions, or some combination thereof, for example instructions that when executed by the processor 801, cause processor 801 to be configured or operable to perform one or more operations of a method as described herein. Bus 815 or other communication components may support communication of information within system 800. The interface 811 may be connected to bus 815 and be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured or operable to perform that which is described in some embodiments.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A method comprising:
generating a first representation of a first image including a first facial identity;
generating an identity representation from a second image that describes a second facial identity of the second image;
mapping the identity representation to a set of low-rank adaptation weights;
adapting the first representation to an adapted first representation using the set of low-rank adaptation weights that are applied to a layer in a model;
generating, by the model, decoder input values based on the adapted first representation; and
performing decoding using the decoder input values to generate an output image, wherein the output image swaps the first facial identity of the first image with the second facial identity of the second image.

2. The method of claim 1, wherein generating the first representation comprises:
splitting the first image into a plurality of patches;
encoding the plurality of patches into a plurality of representations; and
combining the plurality of representations into the first representation.

3. The method of claim 1, wherein generating the identity representation from the second image comprises:
encoding the second facial identity into the identity representation.

4. The method of claim 1, wherein mapping the identity representation to the set of low-rank adaptation weights comprises:
using a mapping network that is trained to map identity representations to low-rank adaptation weights.

5. The method of claim 1, further comprising:
combining the set of low-rank adaptation weights and a set of subject-agnostic weights to generate a set of subject-specific weights, wherein the set of subject-specific weights are applied to the layer.

6. The method of claim 5, wherein the set of subject-agnostic weights are a high-rank weight matrix that are a higher rank than the set of low-rank adaptation weights.

7. The method of claim 6, wherein the set of low-rank adaptation weights are generated based on identity representation to form a matrix of low-rank adaptation weights.

8. The method of claim 1, wherein the set of low-rank adaptation weights are a rank 1 matrix.

9. The method of claim 1, wherein:
the layer is trained to have subject-agnostic weights, and
the set of low-rank adaptation weights are combined with subject-agnostic weights of the layer.

10. The method of claim 1, wherein:
the layer comprises a first layer,
a set of second layers receives the adapted first representation, and
the set of second layers generates the decoder input values.

11. The method of claim 10, wherein:
the set of second layers generate a first decoder input value for scale and a second decoder input value for offset.

12. The method of claim 1, wherein the decoder input values comprise first decoder input values, the method further comprising:
decoding the first representation to generate second decoder input values, and
using the first decoder input values to generate a first output image and the second decoder input values to generate a second output image, and
using the first output image and the second output image to train the model.

13. The method of claim 1, wherein the identity representation is a first identity representation, the method further comprising:
encoding the output image into a second identity representation; and
training the model based on comparing a loss between the first identity representation and the second identity representation.

14. The method of claim 1, further comprising:
training the model using a discriminator that determines whether input images are a first state or a second state, wherein the input images to the discriminator comprise the first image or the output images from the model.

15. The method of claim 1, wherein the identity representation is a first identity representation, the method further comprising:
encoding the output image into a second identity representation;
determining a first loss between the first identity representation and the second identity representation
using a discriminator that determines a second loss on whether input images are a first state or a second state, wherein the input images to the discriminator comprise the first image or the output images from the model; and
using the first loss and the second loss to train the model.

16. The method of claim 1, further comprising:
optimizing the identity representation based on reconstructing multiple images of a source in the second image.

17. A non-transitory computer-readable storage medium having stored thereon computer executable instructions, which when executed by a computing device, cause the computing device to be operable for:
generating a first representation of a first image including a first facial identity;
generating an identity representation from a second image that describes a second facial identity of the second image;
mapping the identity representation to a set of low-rank adaptation weights;
adapting the first representation to an adapted first representation using the set of low-rank adaptation weights that are applied to a layer in a model;
generating, by the model, decoder input values based on the adapted first representation; and
performing decoding using the decoder input values to generate an output image, wherein the output image swaps the first facial identity of the first image with the second facial identity of the second image.

18. The non-transitory computer-readable storage medium of claim 17, further operable for:
combining the set of low-rank adaptation weights and a set of subject-agnostic weights to generate a set of subject-specific weights, wherein the set of subject-specific weights are applied to the second set of layers.

19. The non-transitory computer-readable storage medium of claim 17, wherein the set of low-rank adaptation weights are a rank 1 matrix.

20. An apparatus comprising:
one or more computer processors; and
a computer-readable storage medium comprising instructions for controlling the one or more computer processors to be operable for:
generating a first representation of a first image including a first facial identity;
generating an identity representation from a second image that describes a second facial identity of the second image;
mapping the identity representation to a set of low-rank adaptation weights;
adapting the first representation to an adapted first representation using the set of low-rank adaptation weights that are applied to a layer in a model;
generating, by the model, decoder input values based on the adapted first representation; and
performing decoding using the decoder input values to generate an output image, wherein the output image swaps the first facial identity of the first image with the second facial identity of the second image.
